(19) United States
(12) Patent Application Publication
(10) Pub. No.: US 2024/0099453 A1
(43) Pub. Date: Mar. 28, 2024

(54) TABLE ARRANGEMENT AND TABLE EXTENSION ASSEMBLY FOR USE WITH THE TABLE ARRANGEMENT

(71) Applicant: Gulfstream Aerospace Corporation, Savannah, GA (US)

(72) Inventor: Robert J. Telmos, Savannah, GA (US)

(73) Assignee: Gulfstream Aerospace Corporation, Savannah, GA (US)

(21) Appl. No.: 17/936,188

(22) Filed: Sep. 28, 2022

(51) Int. Cl. A47B 1/04; A47B 1/08; A47B 5/04; A47B 5/06; B64D 11/06

(52) U.S. Cl. CPC A47B 1/04; A47B 1/08; A47B 5/04; A47B 5/06; B64D 11/0605

(57) ABSTRACT

A table extension assembly is disclosed herein. The table extension assembly is for use with a table assembly having a first table section having a first upper surface and a cavity situated below the upper surface, the cavity having an internal surface, and an opening to the cavity disposed proximate a first side surface of the first table section. The table extension assembly includes a second table section having a second upper surface. The table extension assembly further includes an engagement feature extending from a side surface of the second table section. The engagement feature is configured to fit within the cavity, to engage the internal surface and to support the second table section adjacent the first table section such that the second upper surface is flush and contiguous with the first upper surface when the engagement feature is disposed within the cavity and engaged with the internal surface.

### TECHNICAL FIELD

The present invention relates furniture and more specifically to a table arrangement and a table extension assembly for use with the table arrangement.

### BACKGROUND

Space onboard most aircraft is in short supply. This is especially true of business jets. In response, aircraft cabin designers have displayed impressive feats of creativity to use the limited cabin space as efficiently as possible. One space-conscious solution pertains to providing stowable tables. In one embodiment, the solution entails providing a ledge that is affixed to an interior wall of an aircraft's cabin. The ledge is a structure that provides an externally aesthetically pleasing appearance and that conceals an internal hollow space which can be used to stow various accoutrement that are needed periodically, but not constantly, during a flight, such as a table (e.g., a dining table or a desk). Cabin designers have designed tables for use onboard aircraft that fold to fit within the internal hollow space of the ledge.

To fit within the internal hollow space of the ledge, the sections of the foldable dining table cannot exceed a predetermined dimension. While this predetermined dimension may provide an adequate amount of surface area for some passengers and for some applications, for other passengers and for other applications, a greater amount of surface area is desired.

Accordingly, it is desirable to increase the amount of surface area provided by a foldable table without rendering the foldable table incapable of being stowed within the internal space allotted by a storage compartment. Furthermore, other desirable features and characteristics will become apparent from the subsequent summary and detailed description and the appended claims, taken in conjunction with the accompanying drawings and the foregoing technical field and background.

### BRIEF SUMMARY

Various non-limiting embodiments of a table arrangement and a table extension assembly for use with the table arrangement are disclosed herein.

In a first non-limiting embodiment, the table extension is disclosed. The table extension assembly is configured for use with a table assembly. The table assembly has a first table section having a first upper surface and a cavity situated below the upper surface. The cavity has an internal surface. There is an opening to the cavity disposed proximate a first side surface of the first table section. The table extension assembly includes, but is not limited to, a second table section having a second upper surface. The table extension assembly still further includes, but is not limited to, an engagement feature extending from a second side surface of the second table section. The engagement feature is configured to fit within the cavity and to engage the internal surface. The engagement feature is further configured to support the second table section adjacent the first table section such that the second upper surface is flush and contiguous with the first upper surface when the engagement feature is disposed within the cavity and engaged with the internal surface.

In another non-limiting embodiment, the table arrangement includes, but is not limited to, a table assembly. The table assembly has a first table section having a first upper surface and a cavity situated below the upper surface. The cavity has an internal surface. An opening to the cavity is disposed proximate a first side surface of the first table section. The table arrangement still further includes, but is not limited to, a table extension assembly. The table extension assembly is configured for selective engagement with the table assembly. The table extension assembly includes, but is not limited to, a second table section having a second upper surface. The table extension assembly further includes, but is not limited to, an engagement feature that extends from a second side surface of the second table section. The engagement feature is configured to fit within the cavity and to engage the internal surface. The engagement feature is further configured to support the second table section adjacent the first table section such that the second upper surface is flush and contiguous with the first upper surface when the engagement feature is disposed within the cavity and engaged with the internal surface.

### BRIEF DESCRIPTION OF THE DRAWINGS

The present invention will hereinafter be described in conjunction with the following drawing figures, wherein like numerals denote like elements, and

FIG. 1 is a perspective view illustrating an exemplary aircraft suitable for use with the table arrangement and the table extension assembly disclosed herein;

FIG. 2 is a perspective view illustrating an interior portion of the aircraft of FIG. 1,

FIG. 3 is a perspective view similar to FIG. 2 illustrating a non-limiting example of a table assembly for use with the table arrangement of the present disclosure, the table assembly being disposed in an early stage of deployment;

FIG. 4 is a perspective view similar to FIG. 3 illustrating the table assembly in a further stage of deployment;

FIG. 5 is a perspective view similar to FIG. 4 illustrating the table assembly in an even further stage of deployment;

FIG. 6 is a perspective view similar to FIG. 5 illustrating the table assembly in a fully deployed state and further illustrating a non-limiting example of the table extension assembly positioned for coupling with the table assembly;

FIG. 7 is a perspective view similar to FIG. 6 illustrating the table extension assembly coupled with the table assembly to form a non-limiting example of the table arrangement of the present disclosure;

FIG. 8 is an expanded, perspective view illustrating a table section of the table assembly of FIG. 3;

FIG. 9 is an expanded, perspective view illustrating the table extension assembly of FIG. 6;

FIG. 10 is a fragmentary, torn-away, side view of the table arrangement of FIG. 7;

FIG. 11 is fragmentary, torn-away, plan view of an alternate embodiment of the table extension assembly of FIG. 9 just prior to coupling with an alternate embodiment of the table assembly of FIG. 6;

FIG. 12 is a perspective view illustrating the table assembly of FIG. 6 coupled with another alternate embodiment of the table extension assembly of FIG. 9;

FIG. 13 is a perspective view illustrating the underside of another alternate embodiment of the table assembly of FIG. 6; and

FIG. 14 is an exploded view of the table assembly of FIG. 13 and another an embodiment of the table extension assembly.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved table arrangement and table extension assembly for use with the table arrangement are disclosed herein. In a non-limiting embodiment, the table arrangement includes a table assembly and a table extension assembly that is configured to engage the table assembly. The table extension assembly is a distinct component that can be selectively engaged with the table assembly by a user of the table assembly in instances, for example, where a greater amount of surface area is desired by the user. When not needed or desired, the table extension assembly may be stored as “loose equipment” onboard the aircraft.

The table assembly includes a first table section. In some embodiments, the table assembly may include additional table sections that are coupled with the first table section in a foldable manner that permit the first table section and the addition table sections to be folded and retracted for storage. In some embodiments, the table assembly may be mounted to a wall, such as an interior wall of an aircraft cabin, may be unfolded/deployed when needed by a user and may thereafter be folded/retracted for storage when no longer needed. In some embodiments, the table assembly may be mounted to a compartment that is associated with a wall such as a ledge that, in turn, is mounted to an interior wall of an aircraft cabin. In such embodiments, the table assembly may be configured to be folded/retracted and stored within the ledge when not needed so as to be out of sight when stowed, thereby contributing to the appearance of a clean, uncluttered space.

A side surface of the first table section includes an opening to a cavity. As used herein, the term “side surface” refers to an edge of a table section or to a vertically oriented or a substantially vertically oriented side of the table section. The cavity is configured to receive and engage with an engagement feature of the table extension assembly, as discussed below.

The table extension assembly includes a second table section and an engagement feature protruding from a side surface of the second table section. In an embodiment, the engagement feature comprises a protruding planar member that is configured to extend through the opening in the side of the first table section and to be received within the cavity and to engage the interior walls of the cavity. When the engagement feature is seated within the cavity and engaged with the interior walls of the cavity, the second table section is supported by the engagement feature in a cantilever manner adjacent the first table section in a position such that an upper surface of the second table section is both flush and contiguous with the first table section. In this manner, the first table section and the second table section, together, present a passenger/user with a contiguous table surface having a greater surface area than that presented by the first table section alone.

In some embodiments, the table section of the table assembly may be the component that includes the engagement feature and the table extension assembly may be the component that includes the cavity. In some embodiments, the engagement feature may be retractable to facilitate storage of the table extension assembly. In some embodiments, the opening to the cavity may be closed off by a retractable cover to enhance the aesthetic appearance of the table section and to inhibit intrusion by particulate matter such as dust or crumbs.

A greater understanding of the table arrangement and the table extension assembly for use with the table arrangement discussed above may be obtained through a review of the illustrations accompanying this application together with a review of the detailed description that follows.

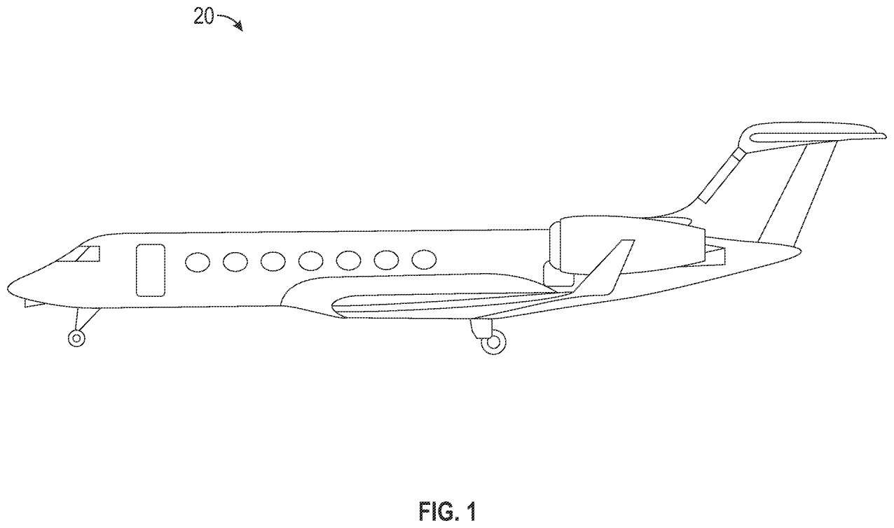

FIG. 1 is a perspective view of a non-limiting embodiment of an aircraft 20 suitable for use with the table arrangement and the table extension assembly of the present disclosure. In the illustrated embodiment, vehicle 20 is depicted as aircraft. While the table arrangement and the table extension assembly disclosed herein are compatible for use onboard an aircraft, and while an aircraft is used as the context for the discussion that follows, it should be understood neither the table arrangement nor the table extension assembly are limited to such use. Rather, the table arrangement and the table extension assembly disclosed herein are compatible with all types of vehicles. Further, the table arrangement and the table extension assembly disclosed herein are not limited to use with vehicles. Rather, they may be used in any conceivable application that calls for increasing the amount of surface area provided by a table, a desk, or any other surface. For instance, and without limitation, the table arrangement and the table extension assembly disclosed herein may be employed in domestic applications as a means to extend or enlarge a dining room table. Further, the table arrangement and the table extension assembly disclosed herein may be employed in business, office, and/or academic settings to serve as a means for increasing available table or desk surface area. Numerous additional conceivable settings and applications are also possible without departing from the teachings of the present disclosure.

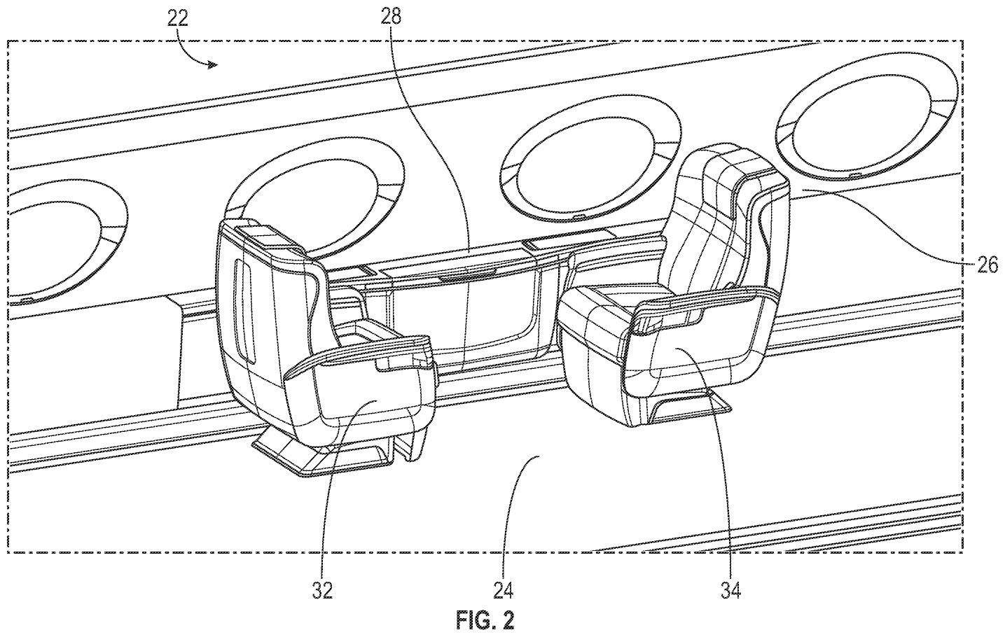

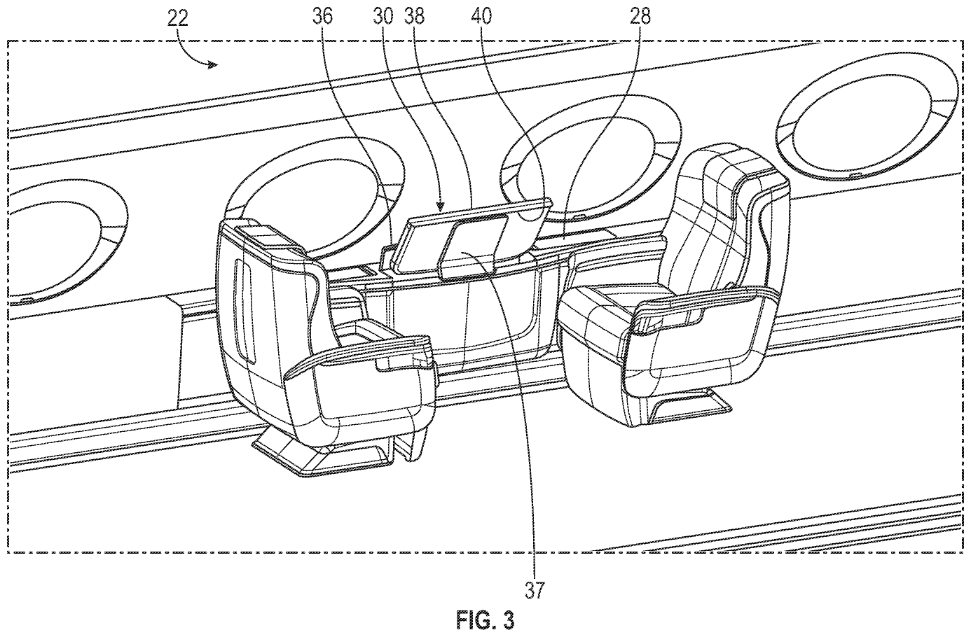

With continuing reference to FIG. 1, FIG. 2 is a perspective view illustrating an interior 22 of aircraft 20. Interior 22 is defined, in part, by a floor 24 and a wall 26. Mounted to wall 26 is a ledge 28. Ledge 28 comprises a compartment for storing a table assembly 30 (see FIG. 3). Positioned adjacent ledge 30 are a passenger seat 32 and a passenger seat 34 which are positioned immediately forward of, and immediately aft of, respectively, the location where table assembly 30 will reside when it has been extracted from ledge 28 and deployed. Passengers seated in passenger seats 32 and 34 will be well situated to use table assembly 30 once it has been deployed to serve as a dining table or as a desk or simply as a horizontal surface to support books, laptop computers, mobile devices, and the like.

With continuing reference to FIGS. 1-2, FIG. 3 is a perspective view illustrating interior 22 with table assembly 30 at an initial stage of deployment. As illustrated, a door 36 to an upper surface of ledge 28 has opened and table assembly 30 has been lifted to an elevated state with respect to ledge 28. As illustrated, an underside of table assembly 30 is supported by a table support 37. When fully deployed, table support 37 will support table assembly 30 in a cantilever manner on an anchor point (not illustrated) disposed within the cavity of ledge 28.

As illustrated in FIG. 3, table assembly 30 includes two table sections, table section 38 and table section 40. Table sections 38 and 40 are pivotably coupled to one another such that table section 38 is configured to rotate with respect to table section 40 in the direction indicated by arrow 42. In the illustrated embodiment, table section 38 is configured to rotate 180 degrees to reside in a position that is longitudinally aligned with table section 40.

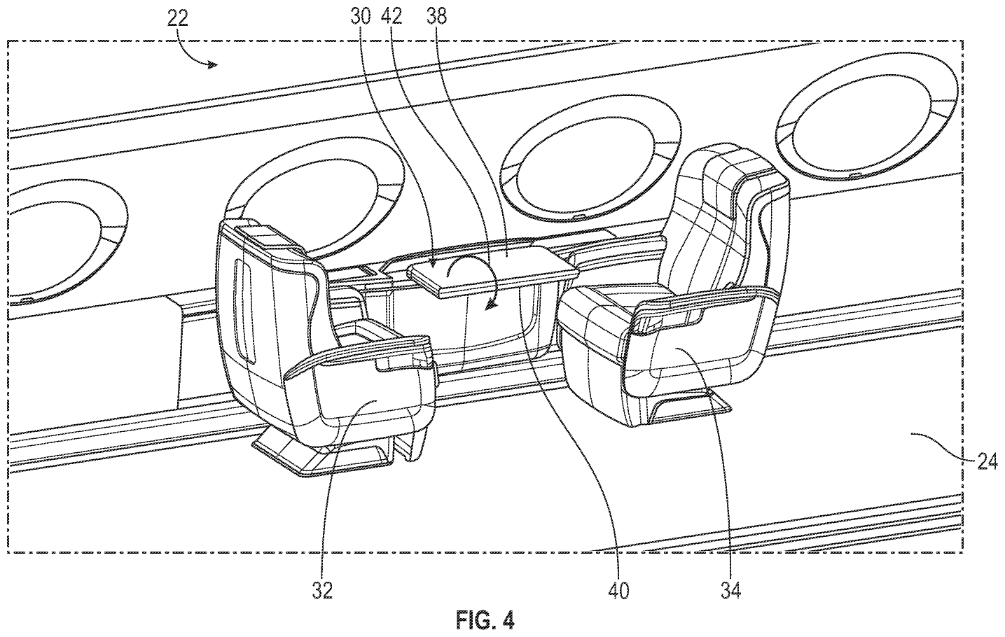

With continuing reference to FIGS. 1-3, FIG. 4 is a perspective view illustrating interior 22 and further illustrating table assembly 30 in a further stage of deployment. In FIG. 4, table assembly 30 has moved to a substantially horizontal orientation with respect to floor 24 and table section 38 remains folded over on top of table section 40.

With continuing reference to FIGS. 1-4, FIG. 5 is a perspective view illustrating interior 22 with table assembly 30 in a fully deployed state. When table assembly 30 is fully deployed, table section 38 has rotated a full 180 degrees with respect to table section 40. Further, table section 38 now resides in a position that is both flush and contiguous with table section 40. This permits table sections 38 and 40 to present a contiguous, substantially uninterrupted horizontal surface to the occupants of passenger seats 32 and 34.

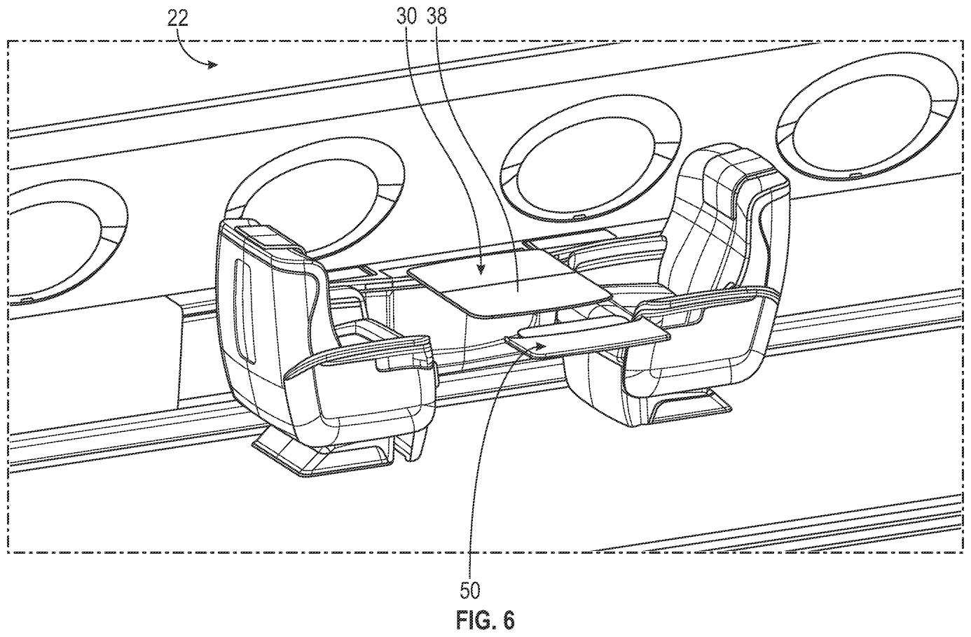

With continuing reference to FIGS. 1-5, FIG. 6 is a perspective view illustrating interior 22 with table assembly 30 in a fully deployed state, just prior to being coupled with table extension assembly 50. As discussed in detail below, table section 38 is configured to engage with table extension assembly 50 and table extension assembly 50 is configured to engage with table section 38.

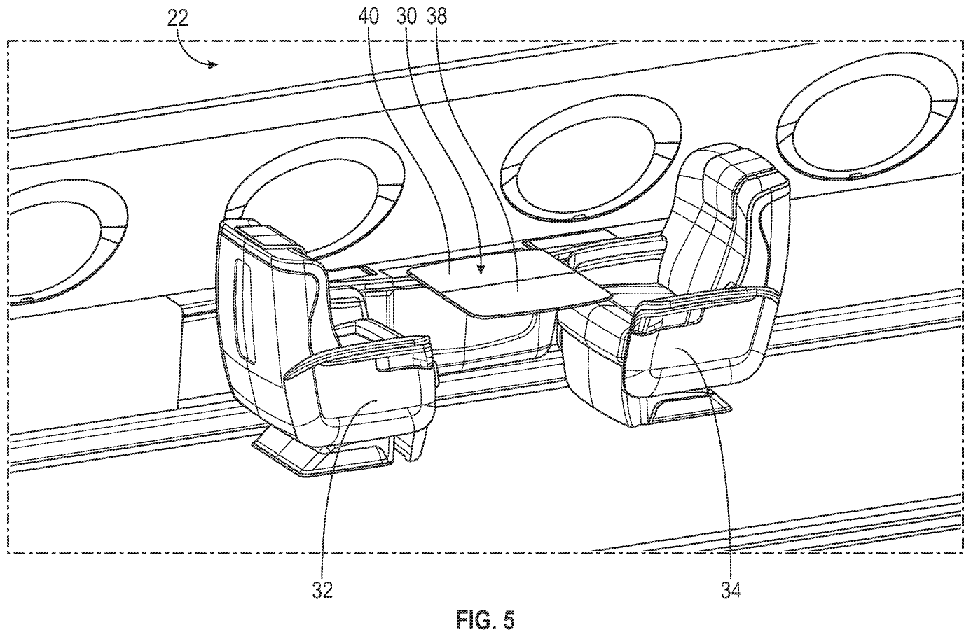

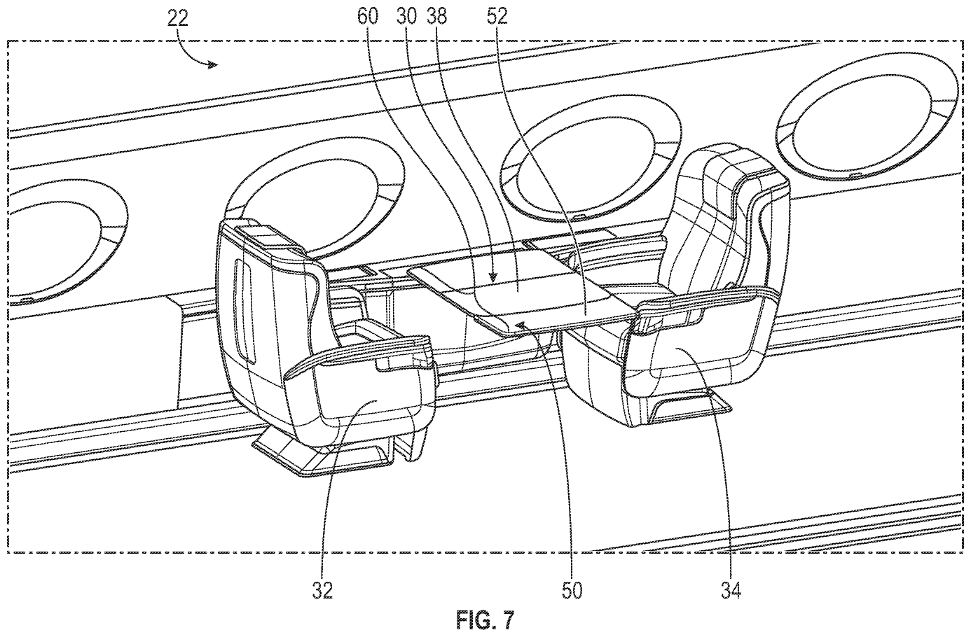

With continuing reference to FIGS. 1-6, FIG. 7 illustrates interior 22 with table assembly 30 and table extension assembly 50 engaged with one another to form table arrangement 60. When table extension assembly 50 is engaged with table assembly 30, a table section 52 of table extension assembly 50 is disposed flush and contiguous with table section 38. In this way, table arrangement 60 provides an occupant of passenger seats 32 and/or 34 with an extended horizontal surface as compared with the horizontal surface provided solely by table assembly 30 (See FIG. 5). This advantageously increases the amount of surface area available to support items utilized by occupants of passenger seats 32 and 34.

With continuing reference to FIGS. 1-7, FIG. 8 is an expanded, perspective view illustrating table section 38. In the illustrated embodiment, table section 38 comprises a single, unitary structure. It should be understood that in other embodiments, table section 38 may be assembled from a plurality of sub-components.

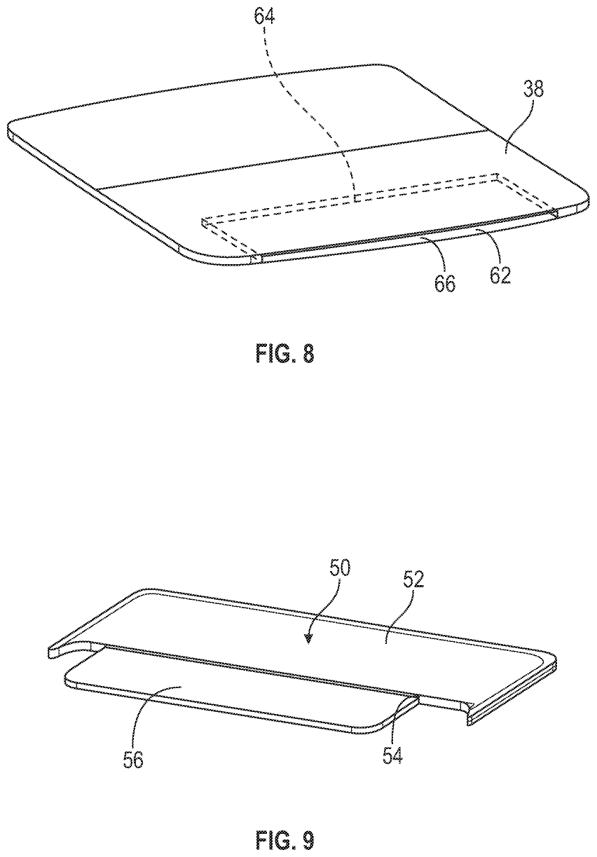

In FIG. 8, an opening 62 to a cavity 64 is visible. Cavity 64 is configured to receive an engagement feature protruding from table extension assembly 50 as discussed below. Cavity 64 is further configured to support the engagement feature and, by extension, to support table extension assembly 50 through engagement between an inner surface 66 and the engagement feature of table extension assembly 30 as described below. In the illustrated embodiment, opening 62 and cavity 64 have a rectangular configuration. It should be understood that in other embodiments, any other suitable configuration that is effective to promote engagement between the engagement feature of table extension assembly 30 and surface 66 defining cavity 62 may be employed without departing from the teachings of the present disclosure. Further, although the illustrated embodiment depicts the use of only a single cavity 64, it should be understood that in other embodiments, a plurality of cavities (and a corresponding plurality of engagement features) may be employed by table arrangement 60 without departing from the teachings of the present disclosure.

With continuing reference to FIGS. 1-8, FIG. 9 is an expanded perspective view illustrating table extension assembly 50. Table assembly 50 includes table section 52 and engagement feature 54. In an embodiment, table section 52 comprises a table portion having the same width and thickness and also the same surface aesthetic appearance as table section 38. In such an embodiment, when table section 52 is positioned adjacent table section 38, their same thickness, width, and aesthetic appearance will contribute to the creation of visual continuity that produces the appearance of a unitary tabletop rather than a conglomeration of disparate tabletops.

Table extension assembly 50 further includes a side surface 54. When table extension assembly 50 is engaged with table section 38, side surface 54 will be positioned adjacent to an inboard side surface/edge of table section 38. In an embodiment, the contour and curvature of side surface 54 will complement/correspond with, and conform to, the contour of inboard side surface/edge of table section 38. This conforming configuration will minimize any gap that might otherwise form between the two components when they are positioned adjacent one another. This further contributes to the appearance of a unitary tabletop.

Table extension assembly 50 further includes an engagement feature 56. In the illustrated embodiment, engagement feature comprises a rectangular planar member that is configured to conform to the contours of inner surface 66 and to thereby promote engagement with cavity 64. Through such engagement, engagement feature 56 supports table extension assembly 50 in a cantilever manner with respect to table section 38. In other embodiments, engagement feature may comprise a plurality of smaller plates or rods the outer collective periphery of which conforms to the contours of cavity 64. In still other embodiments, engagement feature 56 may have any other suitable configuration that conforms to the contours of cavity 64 and that is effective to engage with surface 66 and to support table extension assembly 50 adjacent table section 38 without departing from the teachings of the present disclosure.

In an embodiment, table extension assembly 50 may be machined from a single blank and may therefore comprise a single, unitary structure. In other embodiments engagement feature 56 and table section 52 may be separate components that are coupled together through any conventional means of joining distinct components.

In the illustrated embodiment, engagement feature 56 protrudes from a central region of side surface 54. In some embodiments, engagement feature 56 may protrude from a precise center of side surface 54. In other embodiments, engagement feature 56 may be vertically or laterally offset from the precise center of side surface 54 without departing from the teachings of the present disclosure.

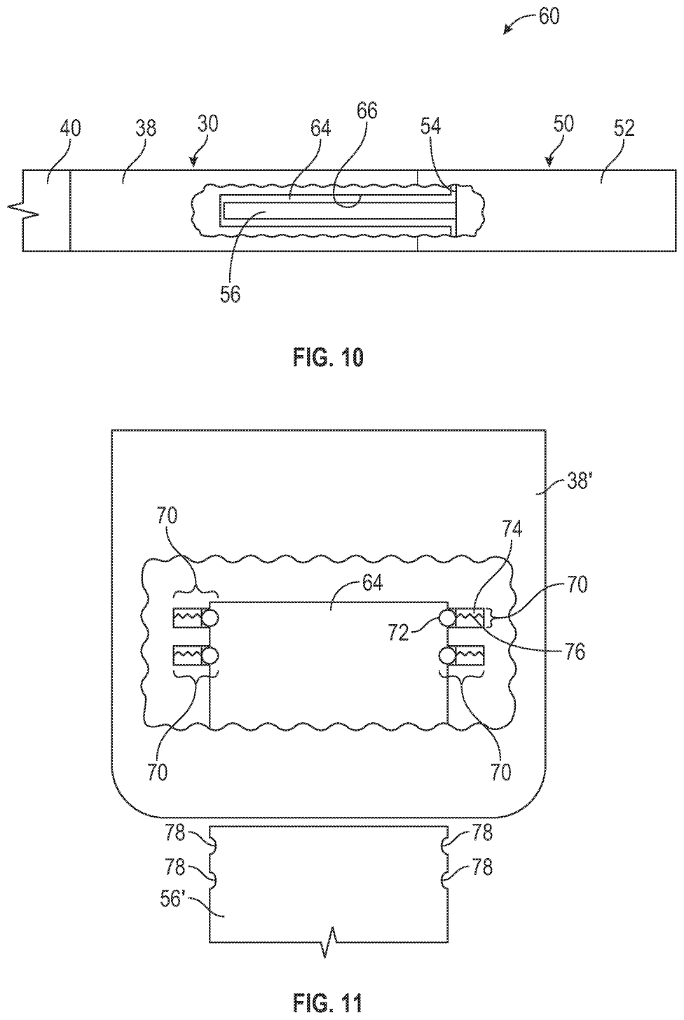

With continuing reference to FIGS. 1-9, FIG. 10 is a fragmentary, torn-away side view of table arrangement 60. As illustrated, table assembly 30 and table extension assembly 50 are engaged with one another and table extension assembly 50 is supported through a cantilever engagement between engagement feature 56 and inner surface 66 of cavity 64. For ease of illustration, there is space interposed between inner surface 66 and an outer surface of engagement feature 56 and also between side surface 54 and a side surface/edge of table section 38. In an actual embodiment, these interposed spaces would be absent or greatly reduced and there would be direct engagement between the surfaces of the two components.

As illustrated, an upper surface of table section 52 is flush and contiguous with an upper surface of table section 38 which, in turn, is flush and contiguous with an upper surface of table section 40. Similarly, a lower surface of table section 52 is flush and contiguous with a lower surface of table section 38 which, in turn, is flush and contiguous with a lower surface of table section 40. This flush and contiguous arrangement contributes to the aesthetically pleasing appearance of table arrangement 50 and also to the creation of the appearance of a unitary table structure at the core of table arrangement 50.

With continuing reference to FIGS. 1-10, FIG. 11 is a fragmentary, torn-away plan view illustrating an alternate embodiment of table section 38 (table section 38′) and an alternate embodiment of engagement feature 56 (engagement feature 56′). Table section 38′ includes a plurality of ball catches 70. In the illustrated embodiment, each ball catch 70 includes a ball bearing 72, a ball bearing housing 74, and a spring 76. Ball bearing 72 is configured to translate within housing 74 and is outwardly biased by spring 76. An exit of housing 74 has a diameter that is narrower than the diameter of ball bearing 72 and therefore ball bearing 72 partially protrudes through the housing exit without exiting the housing. Engagement feature 56′ includes four detents 78. Each detent 78 is disposed at a location that will correspond with each protruding ball bearing 72 when engagement feature 56′ is fully seated withing cavity 64. This will allow the ball bearings to protrude into the void formed by each detent 78 and create an interlocking engagement between cavity 64 and engagement 56′. This interlocking engagement will inhibit the removal of engagement feature 56′ from cavity 64 unless a predetermined amount of force is exerted that is sufficient to overcome the force exerted by each spring 76 on ball bearing 72 and drive each ball bearing 72 backwards into its respective ball bearing housing 74. This interlocking engagement will therefore inhibit unintended disengagement of table extension assembly 50 from table section 38.

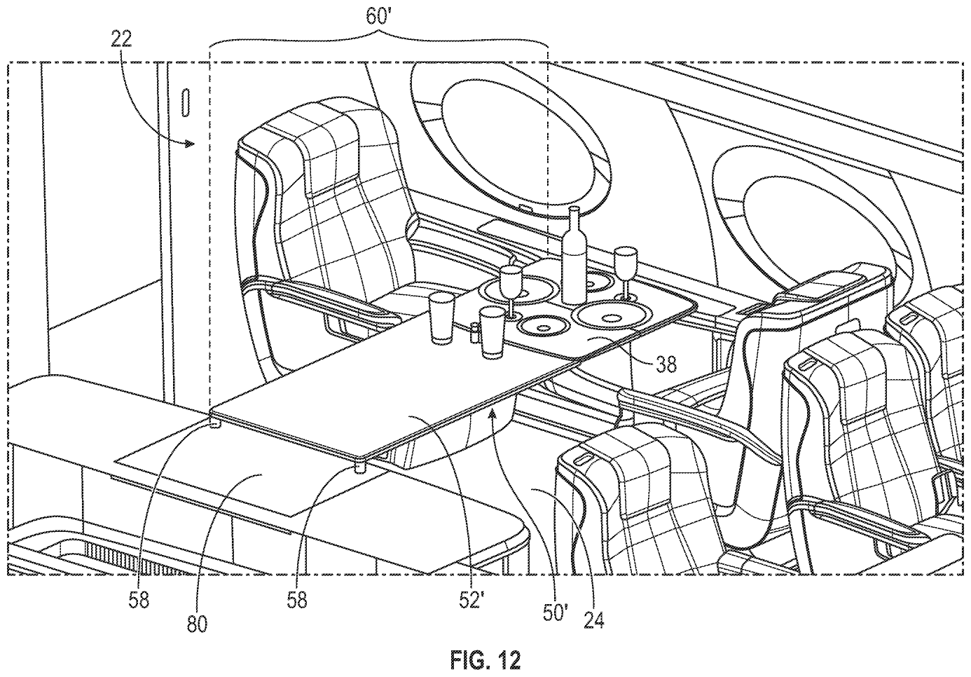

With continuing reference to FIGS. 1-11, FIG. 12 illustrates an interior 22 and an alternate embodiment of table arrangement 60 (table arrangement 60′) that includes an alternate embodiment of table extension assembly 50 (table extension assembly 50′) that includes an alternate embodiment of table section 52 (table section 52′). The primary difference between table section 52 and table section 52′ is that table section 52′ is much longer than table section 52. Because of its increased length, the cantilever support provided by engagement feature 56 is insufficient to support table section 52′ in a steady, stable position with respect to table section 38 above floor 24. Accordingly, additional support features are required. In the illustrated embodiment, table section 52′ includes a pair of legs 58 that are configured to support a distal end of table section 52′ above a support surface present in interior 22. In the illustrated embodiment, pair of legs 58 are supporting the distal end of table section 52′ on a credenza 80. In other embodiments in which the environment of interior 22 does not include credenza 80 or any other structure to support pair of legs 58, pair of legs 58 may be configured to extend from an underside of table section 52′ all the way down to floor 24.

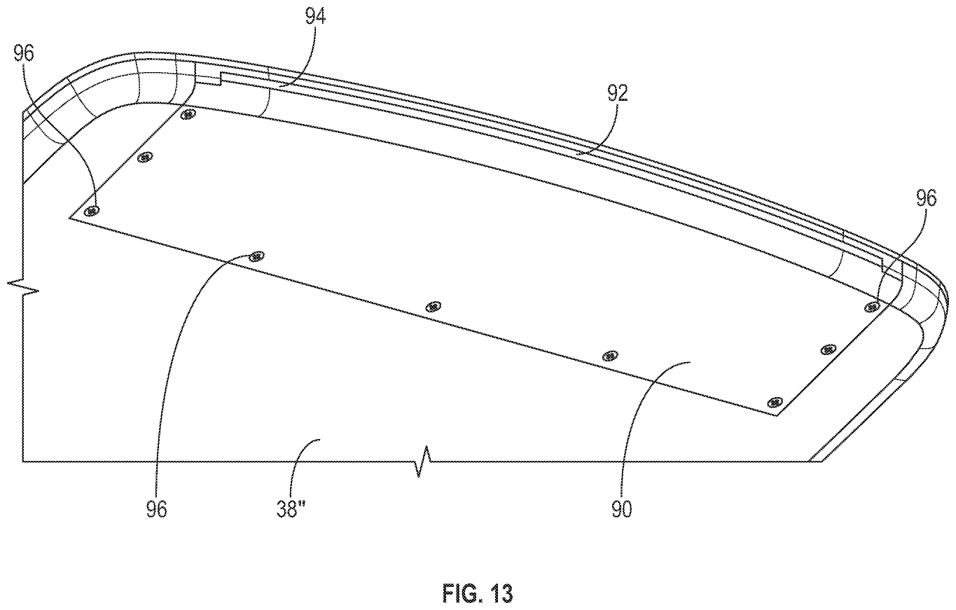

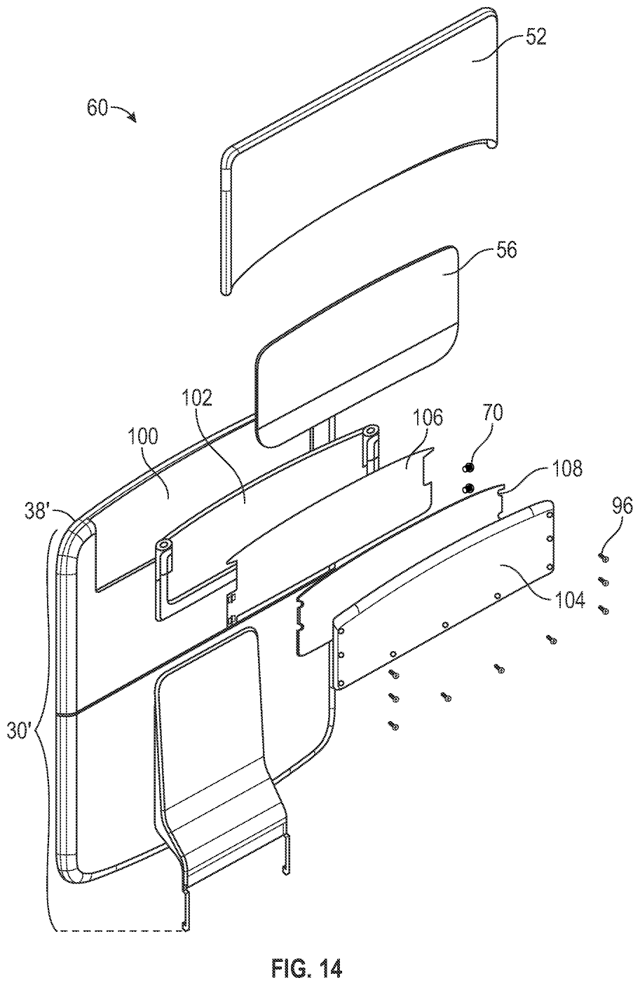

With continuing reference to FIGS. 1-12, FIG. 13 is a perspective view illustrating another alternate embodiment of table section 38 (table section 38″). Unlike table section 38 which includes a cavity (cavity 64) that is defined directly into table section 38 by inner surface 66, table section 38″ instead has a carve out (see FIG. 14) that is configured to receive a retention housing 90. Retention housing 90 is an assembly of components, discussed in detail below, that is configured to form a cavity 92 and an opening 94 that provides access to an engagement feature of table extension assembly 50 (e.g., engagement feature 56 or engagement feature 56′) to facilitate engagement between table extension assembly 50 and table section 90.

Retention housing 90 may be coupled with table section 38″ in any suitable manner that is effective to form a robust connection. In the illustrated embodiment, a plurality of threaded fasteners 96 have been employed to semi-permanently mount retention housing 90 to table section 50. In other embodiments, any other mechanism or means of effecting a robust connection may be employed without departing from the teachings of this disclosure.

As illustrated, retention housing 90 fits entirely within the carveout defined in table section 38″ such that a lower surface of retention housing 90 and a lower surface of table section 38″ are both flush and contiguous with one another. This results in a smooth and substantially uninterrupted surface being presented to the legs of a user seated at passenger seats 32 and 34 and avoids any protrusions or intrusion into the space that is otherwise reserved for the passenger's legs.

With continuing reference to FIGS. 1-13, FIG. 14 is an exploded view of an alternate embodiment of table arrangement 60 (table arrangement 60′) that includes an alternate embodiment of table assembly 30 (table assembly 30′) that, in turn, includes table section 38′. In this view, the carveout discussed above (a carveout 100) can be observed. Carveout 100 is configured to receive retention housing 90.

Retention housing 90 is also illustrated in an exploded manner. Retention housing 90 includes an upper retention plate 102 and a lower retention plate 104 that are configured to form cavity 92 and opening 94 when upper retention plate 102 and lower retention plate 104 are engaged with one another. Also included in retention housing 90 are an upper felt pad 106 and a lower felt pad 108. Felt pad 106 and felt pad 108 may be secured to upper retention housing 102 and lower retention housing 104, respectively, in any suitable manner. Felt pads 106 and 108 reside in cavity 92 and are intended to facilitate a smooth, quiet, and seamless insertion of engagement feature 56 or 56′ into cavity 92 and a smooth, quiet, and seamless extraction of engagement feature 56 or 56′ therefrom.

Also illustrated in FIG. 14 are a plurality of ball catches 70. As discussed above, ball catches 70 are configured to facilitate a robust engagement between cavity 92 and engagement feature 56′.

Securing each of the individual components of retention housing 90 together are a plurality of threaded fasteners 96. Each individual component of retention housing 90 are configured to receive threaded fastener 96. Further, the plurality of threaded fasteners 90 not only hold retention housing 90 together, but also secure retention housing 90 to table section 38′ within carveout 100.

Also illustrated in FIG. 14 is table extension assembly 50′ including table section 52 and engagement feature 56′. As discussed above, engagement feature 56′ is configured to robustly engage with ball catches 70 to, in turn, provide robust engagement between table extension assembly 50′ and table assembly 30′.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A table extension assembly for use with a table assembly, the table assembly having a first table section having a first upper surface and a cavity situated below the upper surface, the cavity having an internal surface, an opening to the cavity disposed proximate a first side surface of the first table section, the table extension assembly comprising:
a second table section having a second upper surface; and
an engagement feature extending from a second side surface of the second table section, the engagement feature configured to fit within the cavity and to engage the internal surface, the engagement feature further configured to support the second table section adjacent the first table section such that the second upper surface is flush and contiguous with the first upper surface when the engagement feature is disposed within the cavity and engaged with the internal surface.

2. The table extension assembly of claim 1, further comprising a retention feature configured to inhibit unintentional disengagement of the engagement feature from the internal surface of the cavity when the engagement feature is engaged with the internal surface of the cavity.

3. The table extension assembly of claim 2, wherein the retention feature comprises one of a detent and an outwardly biased protruding member configured to engage the detent.

4. The table extension assembly of claim 1, the cavity having a first contour, wherein the engagement feature has a second contour corresponding with, and conforming to, the first contour.

5. The table extension assembly of claim 1, the first table section having a first width, the second table section having a second width that coincides with the first width.

6. The table extension assembly of claim 1, wherein the second table section and the engagement feature are comprised of aluminum.

7. The table extension assembly of claim 1, wherein the engagement feature is completely concealed within the cavity when the engagement feature is engaged with the internal surface of the cavity.

8. The table extension assembly of claim 1, wherein the engagement feature comprises a planar member coupled with the second table section.

9. The table extension assembly of claim 1, wherein the engagement feature extends from a central region of the second side surface of the second table section.

10. The table extension assembly of claim 1, the first side surface of the first table section having a first contour, wherein the second side surface of the second table section has second contour that conforms to the first contour.

11. The table extension assembly of claim 1, the first table section having a first lower surface situated below the cavity, wherein the second table section has a second lower surface and wherein the engagement feature is configured to support the second table section adjacent the first table section such that the second lower surface is flush and contiguous with the first lower surface when the engagement feature is disposed within the cavity and engaged with the internal surface.

12. The table extension assembly of claim 1, wherein the engagement feature is configured to support the second table section adjacent the first table section in a cantilever manner when the engagement feature is engaged with the internal surface of the cavity.

13. The table extension assembly of claim 1, the first upper surface of the first table section having a first decorative appearance, wherein the second upper surface of the second table section has the first decorative appearance.

14. The table extension assembly of claim 1, wherein the second table section has a proximal end and a distal end, wherein the proximal end is disposed adjacent the first table section when the engagement feature is engaged with the internal surface of the cavity, and wherein the table extension assembly further comprises a supporting structure coupled with the second table section proximate the distal end, the supporting structure configured to support the distal end of the second table section above a supporting surface.

15. The table extension assembly of claim 14, wherein the supporting structure comprises a plurality of table legs.

16. The table extension assembly of claim 1, wherein the engagement feature is coplanar with an imaginary plane extending through the first table section when the engagement feature is engaged with the internal surface of the cavity.

17. A table arrangement comprising:
a table assembly having a first table section having a first upper surface and a cavity situated below the upper surface, the cavity having an internal surface, an opening to the cavity disposed proximate a first side surface of the first table section; and
a table extension assembly configured for selective engagement with the table assembly, the table extension assembly including:
a second table section having a second upper surface; and
an engagement feature extending from a second side surface the second table section, the engagement feature configured to fit within the cavity and to engage the internal surface, the engagement feature further configured to support the second table section adjacent the first table section such that the second upper surface is flush and contiguous with the first upper surface when the engagement feature is disposed within the cavity and engaged with the internal surface.

18. The table arrangement of claim 17, wherein the first table section is configured to be coupled with a supporting surface and to be stowed within the supporting surface.

19. The table arrangement of claim 17, further comprising a retention housing coupled with an underside of the first table section, wherein the first table section has a carveout to accommodate the retention housing such that an underside of the retention housing is flush and contiguous with a lower surface of the first table section, and wherein the retention housing defines the cavity.

20. The table arrangement of claim 17, further comprising a first felt pad and a second felt pad, the first felt pad coupled with an upper internal surface of the cavity and a second felt pad coupled with a lower internal surface of the cavity.
